(19) United States
(12) Patent Application Publication
(10) Pub. No.: US 2012/0236994 A1
(43) Pub. Date: Sep. 20, 2012

(54) Method of characterizing integrated memory structures

(75) Inventor: Andreas Hieke, San Mateo, CA (US)

(73) Assignee: Andreas Hieke, San Mateo, CA (US)

(21) Appl. No.: 13/135,192

(22) Filed: Jun. 27, 2011

Related U.S. Application Data
(60) Provisional application No. 61/358,822, filed on Jun. 25, 2010.
(60) Provisional application No. 61/358,944, filed on Jun. 28, 2010.

(51) Int. Cl. G01N 23/20; B82Y 35/00

(52) U.S. Cl. 378/71; 977/901

(57) ABSTRACT

A method of determining the deviation of measured pattern vs. computed pattern is disclosed. Other methods are also disclosed herein.

### RELATED APPLICATIONS

This application claims priority to U.S. Provisional Application No. 61/358,822, filed Jun. 25, 2010, and U.S. Provisional Application No. 61/358,944, filed Jun. 28, 2010, both of which are incorporated by reference in their entirety.

### FIELD OF INVENTION

The present invention relates generally to a method of determining the deviation of a measured pattern versus a computed pattern. More particularly the present invention relates to determining the deviation of a measured pattern of integrated circuits versus a computed pattern of integrated circuits.

### BRIEF DESCRIPTION OF DRAWINGS

To facilitate further description of the embodiments, the following drawings are provided. The same reference numerals in different figures denote the same elements.

FIG. 1 shows an example of a principle arrangement for measuring diffractive patterns of electromagnetic waves on integrated structures according to one embodiment of the present invention.

FIG. 2 shows an example of a wafer comprising several chips according to an embodiment of the present invention.

FIG. 3 shows an example of memory arrays that can be considered as crystals when considering the sense of diffraction according to an embodiment of the present invention.

FIG. 4 shows a method of determining the deviation of measured pattern vs. computed pattern according to one embodiment of the present invention.

FIG. 5 shows a method of minimizing the deviation of computed pattern and measured pattern according to one embodiment of the present invention.

### DETAILED DESCRIPTION

Integrated circuits are being manufactured at increasingly smaller critical dimensions (CD), i.e., the typical size of the smallest lateral features becomes smaller in order to achieve an increase in integration density. While current commercially available state of the art chips have CDs of 45 nm, within the next few years these sizes will be significantly reduced. For example, it is expected the next steps will be approximately 32 nm, 22 nm, 16 nm, and 11 nm, and potentially even smaller.

For the development of the fabrication processes, and also for the subsequent stable execution of the various involved process steps to fabricate the various structures on integrated circuits, it is essential to characterize what is being built, i.e., to have feedback on how well the process steps are performed and which parameters can be used to optimize them.

The characterization typically concerns the geometrical accuracy with which features and structures on the chip, typically produced by etch, deposition, or implantation of material, are created. Of interest are, for example, line roughness, side wall angles, depth of etches, etc., and variation of such measures across each chip, as well as across the whole wafer. Historically, electron microscopes have been well suited to obtain images of the fabricated features and structures.

However, the reduced CD makes it increasingly more difficult to measure and characterize how well such structures are built, since even scanning electron microscopes have finite resolution on the order of several nanometer and limited image quality at such high spatial resolution.

Therefore, there is a practical need for a method to measure and characterize structures on integrated circuits with critical dimensions on the order of several 1 Os of nanometers, or even only several nanometers.

It is possible to characterize periodic structures on atomic scales by means of diffraction of electromagnetic waves. Such methods and related apparatuses can be used to determine the crystallographic structure of numerous inorganic materials and even organic molecules such as proteins, provided such molecules can be arranged in periodic manner, i.e., they can by crystallized.

The present invention comprises a method of comparing a measured pattern versus a computed pattern. Further, in some embodiments, the present invention determines the deviation of a measured pattern versus a computed pattern. In addition, in some embodiments, the present invention comprises a method of determining manufacturing defects in integrated circuits when compared to the computed design of the integrated circuits. In yet other embodiments, the present invention comprises a method of optimizing the design of integrated circuit in preparation of manufacturing.

The current invention is at least in part based on the realization that at least some of the integrated structures that are fabricated on integrated circuits are highly periodic in one or more dimensions. In particular this concerns memory cells which are used to store information. Typical examples can include, such as, DRAMs, SRAM, PROM, EPROM, EEPROM, MRAM, FeRAM, NRAM, T-RAM, Z-RAM, PMC, Flash memory (“FlashRAM”) or similar configurations. The common aspect of all these devices is that they are arranged on a chip in a periodic manner, typically in two or sometimes one dimension. Future generations of memory chips may also introduce a 3^{rd} dimension in which there is periodicity.

This periodic arrangement is achieved by repeating the essentially identical structure of the so called ‘memory cell’ over and over again in typically at least two dimensions. Thereby arrays of memory cells are formed. They can contain a little as a few 100 to up to several 10s of billions of cells and in future even more.

Such memory cell may represent the primary function of a given integrated circuit, such as typically, but not exclusively, in case of DRAMs or FlashRAMs, or they are only a part of an integrated circuit, such as, for example, in case of SRAM cells, which may function as cache or data buffers on CPUs or GPUs.

Future memory cells may be based on other physical principles to store information as those used today (as mentioned above), but nevertheless they will form periodic arrays of repetitive units.

The present inventions concerns the use of electromagnetic radiation of suitable wavelength to generate and measure diffractive patterns of such periodic integrated structures, in particular, memory cells, and to use such measurements to obtain information about the quality with which the structures were made, which may also serve to optimize the processes involved in their production.

It shall be understood that the terms ‘electromagnetic radiation’ and ‘electromagnetic waves’ are used in a synonymous manner. Electromagnetic radiation, specifically of relatively small wave length (such as so called hard and soft X-rays) has both properties which can be best described by the concept of a wave, but has also properties which can best be described by the concept of individual quanta, i.e. photons.

It shall be understood that terms ‘integrated circuit’ and ‘chip’ are used in a synonymous manner.

Theoretically, perfectly made, infinitely large repetitive structures under ideal illumination conditions will cause spatially infinitely sharp diffraction maxima. The finite size of repetitive patterns (or at least the finite size of the repetitive pattern exposed to radiation) as well imperfections of repetitive structures will not cause a fundamental change of the expected diffractive pattern, but rather cause a degradation of the diffraction pattern, which may include a broadening or general deformation of diffraction peaks, change in the intensity of higher order peaks, overlapping of peaks, and other effects.

Such influence is typically considered disadvantageous and, if possible, avoided or minimized at all cost, since the goal of a typical analysis by means of diffraction of electromagnetic waves is to determine the (size of the) periodicity of the repetitive structure, as well as the shape of the repetitive structure (such as a molecule), and any degradation of the diffractive signal makes it more difficult (or in some cases even impossible) to make this determination.

However, as disclosed herein, one can use this degradation of the diffractive pattern as information, i.e., as a signal of interest, if the periodic structure is at least in part known and the desired information is the perfection, or quality, or degree of variation among the contained building block, with which the repetitive structure was made.

Such prior knowledge is available in case of periodic structures on integrated circuits, in particular in case of memory cells, since such structures were made on purpose in a highly repetitive manner. In addition, the theoretical geometric location of all contained features is known and available from the design data of the chip, i.e. layout data, which are required to fabricate masks, in case a lithographic process is used to make the chip. In some other instances the layout data are feed into an electron beam lithography machine and the corresponding spatial patterns are directly written onto the wafer or chip.

The disclosed method exposes a portion of an integrated circuit, typically while still part of a wafer and while still incompletely manufactured, to a beam of electromagnetic radiation, which creates a diffractive pattern that is measured. This process may be repeated for exposure under different angles and orientations, including orientation of polarization, if polarized waves are used.

In some embodiments a diffractometer or a diffractometer like arrangement may be used to execute the measurement. Some of the elements used in such an arrangement may contain a radiation source, means to shape the beam of radiation, means to focus and/or collimate the beam, means to position the chip or the wafer (i.e. the sample) relative to the incoming beam of radiation by translation and/or rotation, means to move one or more sensors of the radiation, either by translation (typically to change distance to the sample in order to change spatial resolution) and/or by rotation on the surface of a sphere, the origin of which is proximity of the center of the exposed spot on the chip (in order to spatially scan the diffracted pattern if required). Combinations of such relative motions may be used. Furthermore, elements may be used to filter out the desired wavelength, both prior and after the diffraction event, which will increase signal quality and signal-to-noise ratio (e.g., for suppression signals from fluorescence). Finally 0, 1, or 2 dimensional detectors for the detection and quantification of the diffracted radiation are used which feed their data to one or more computers.

Using the obtained diffractive pattern, it is in general impossible to directly and unambiguously calculate (backward) the periodic structure that caused the diffractive pattern. (An exception is if a source of coherent radiation is available for the chosen wavelength as well as phase sensitive detectors in which case phase information is obtainable and the process of diffraction can be mathematically inverted. Once such sources and detectors become available the disclosed method should take advantage of it and may not need to rely on the subsequently outlined iterative scheme.)

Therefore, the disclosed method may use an iterative analytical and/or numerical data analysis, whereby at least in part known (ideal) layout data of the chip that typically determine the lateral features of the chip, and sometimes also in conjunction with other known process data that typically determine the thickness of structures, are used to compute a first theoretical diffractive pattern. This may also take into account the finite number of periodic repetitive structures on the chip, exposed to the incoming beam of electromagnetic radiation.

Then the spot of the incoming electromagnetic wave may be placed on the interrogated chip, such that the substantially same area that was used for said calculation is exposed to the electromagnetic radiation, either by accurate mechanical alignment, possibly in conjunction with other detection means (e.g. electron microscopes), and/or by observing the diffracted pattern.

In one embodiment of the disclosed invention some features of the measured diffractive pattern or patterns are directly used to obtain some quantification for imperfections of the fabricated structure. Such characteristic features of the measured diffractive pattern may be the width of peaks, asymmetry of peaks, or the angular dependence of the intensity change of higher order peaks.

In another embodiment of the disclosed invention, an iterative process may now be started that numerically introduces variations to the ideal layout data and process data, which replicate the effects of typical process variations and deviations of the actual lithographically generated structure from the structure on the mask.

Then the new expected diffractive pattern (which also includes said assumed errors in fabrication) is computed and compared to the observed pattern and the deviation between the quantified. This process is repeated many times and for various assumed variations and errors in the fabricated structure. This can, as mentioned, include assumed changes in sidewall angle, variations in sidewall angles, line roughness and variation thereof, thickness variations, surface roughness and variation thereof, variation on local periodicity, i.e. local misalignment etc.

The goal is to find assumed structures that minimize the deviation of computed and measured diffractive pattern. This allows one to eventually find structures or classes of structures that are typical for those that were manufactured or at least deviate by a known degree.

In general several dimensions of the conceptual space of variation may be sampled by these forward simulations and the numerical and computational effort can be considerable. However, in general, the more such cases with different kinds of variations, and different degrees of variation, and combinations thereof are computed, the more accurate statements about the actually fabricated structure can be made, since the deviation of simulated and measured diffractive pattern is reduced.

Various numerical methods may be employed to achieve this high-dimensional optimization, including, for example, Monte Carlo methods, Gradient methods, Genetic Algorithms, and combinations thereof.

According to the disclosed invention, the fabricated basic repetitive structure is identical to a unit cell in crystallographic sense (i.e. from the viewpoint of the generation of the diffractive pattern), which may in some instances also be identical to a memory cell. Memory cells can be considered as, typically 2-dimensional, artificial crystals in terms of diffraction of electromagnetic waves.

The actual computation of the diffractive pattern may include a first step in the electromagnetic scattering behavior of one receptive unit, i.e., of the unit cell in sense of the diffraction, is determined by analytical or numerical methods or a combination thereof. Then the response of the entire exposed structure is computed by superposition of the individual scattering events thereby modeling the effect of diffraction. The discussed errors may be introduced on both levels (i.e., by assuming a number of slightly different unit cells, which scatter slightly differently, and then composing the entire diffracted pattern from a number of classes of such unit cells). Various analytical and numerical methods may be used to accelerate the computational process to arrive at a result of sufficient accuracy. One possible method to obtain the scattering information for the unit cell may be based on so called full wave solvers of Maxwell's equations, such as FDTD solvers or FEM solvers for stationary solutions of harmonic problems of Maxwell's equations. Superposition for modeling of the diffraction may be based on analytical representation of the obtained scattering responses of unit cells or on superposition of raw numerical data.

One particular advantage of the disclosed method is that it can be used on the actual chip itself, as long as the interrogated spot contains at least some repetitive features, and one does not need to rely on dedicated test structures that are outside the actual active area of the integrated circuit.

While such dedicated one or two-dimensional test structures may be advantageous in some cases, and the use of such on-chip (yet outside the active functional area) test structures shall be considered part of the invention, typically, the area used for such dedicated test structures is minimized for mature chips in order to maximize yield, i.e., to increase the number of sellable chips per wafer.

Another advantage of being able to measure on the functional area of the chip itself is the ability to quantify variation of the measured features across the chip.

Yet another advantage of measurements on the actual functional features on the chip is that this permits more accurate statements about the quality of fabrication compared to artificial test structures (such as simple arrays lines or arrays of rectangles or dots), since the features present in the vicinity of a given point on the chip influence to some degree the physical and chemical processes used to fabricate the chip on that spot. In other words, artificial test structures are only to some degree representative of actual functional structures on the chip (which tend to be more complicate). Such deviations between artificial test structures and functional structures may be caused by optical effects (e.g., known form OPC corrections) or by slight changes in local aerodynamics and etch rates during plasma based processes, or minute changes in local deposition rate, or dependence of polishing strength on feature size, to name a few.

The disclosed method to use diffractive patterns of electromagnetic radiation to determine certain aspects of the geometry of the fabricated structures can be used during and after the various process steps to fabricate integrated circuits such as, for example, during and after the various process steps in the manufacturing of memory cells. Such examples include during and after fabrication of wordlines, or during and after fabrication of bitlines in RAM cells. It may be noted that DRAMs are considered a technology driver, since leading edge processes to fabricate integrated circuits are frequently developed for the fabrication thereof.

One possible embodiment of this method may attempt to determine specifically the dimensions and precision with which metal lines on the chip or wafer were fabricated or deposited. Such lines, typically made from Aluminum, Copper, Tungsten, or other conductors, are used to electrically connect various components on the chip.

One possible embodiment of this method may attempt to determine specifically the dimensions and precision with which features on the chip or wafer were removed. Such removal is typically accomplished by various etch processes and the created voids are filled with other materials in later process steps.

One possible embodiment of this method may attempt to determine specifically the dimensions and precision with which semiconducting features on the chip or wafer were fabricated or deposited. Such semiconductors are typically bipolar or unipolar transistors, specifically FETs, as well as diodes and are the active, i.e. amplifying components of the chip.

One possible embodiment of this method may specifically attempt to determine the dimensions and precision with which carbon nanotubes on the chip or wafer were fabricated or deposited or aligned. Such carbon nanotubes may for example serve as electrical connectors or may be part of structures which are amplifying or switching electric current. In one specific example such carbon nanotubes may eventually form transistors, be part of transistors, or at least are functional units which have electric characteristics similar to transistors and are used, at least in part, as a replacement for transistors.

In one particular embodiment such carbon nanotubes may form areas with a number of relatively long nanotubes aligned in parallel, thereby effectively forming large 1-dimensional patterns. In another embodiment such carbon nanotubes may form areas with a number of relatively short nanotubes aligned in parallel as well as in another dimension, thereby effectively forming large 2-dimensional patterns. In another embodiment such carbon nanotubes may form areas with a number of relatively short nanotubes aligned in parallel as well as in 2 other dimensions, thereby effectively forming large 3-dimensional patterns. Such patterns formed by nanotubes may extend over parts of each individual chip or may extend over larger areas. In some cases such patterns formed by nanotubes may extend over almost the entire wafer. The described method may specifically be used to determine the perfection with witch such n-dimensional patterns of nanotubes were made or aligned.

It is to be understood that the structural basis for carbon nanotubes are two-dimensional layers of carbon atoms (graphene) and that such layers may be used to form 3-dimensional structures which deviate from the perfect circular cross section of carbon nanotubes. The above described examples of the disclosed invention shall also cover these cases. Furthermore, in other embodiments of the invention the interrogated nanotubes may be made from other elements than carbon.

Chips or wafers interrogated with the disclosed method, which are incorporating such nanotubes may predominantly be memory chips or may be predominantly logic chips, or may be a combination thereof.

One possible embodiment may utilize a source of electromagnetic radiation that uses electron beams to generate waves of suitable wavelength. Another possible embodiment may utilize a source of electromagnetic radiation that uses plasma to generate waves of suitable wavelength. Yet another possible embodiment may utilize a source of electromagnetic radiation that uses deceleration or acceleration of free electric charges, such as, for example, in free electron lasers.

Frequently the generated spectrum may contain various wavelengths simultaneously, and a subsequent filtering may be required to select only one particular wavelength. In many cases a high brilliance of the source of electromagnetic radiation may be desirable.

Further desirable, at least from a standpoint of the generation and measurement of the diffractive pattern, is to have the possibility to choose the wavelength according the periodicity and feature size of the interrogated structure. However, in many cases, there are only certain characteristic wavelengths available, e.g. if the excitation of electrons in metals by impinging electron beams is used to generate the radiation. There may also be limitations on which wavelength can be efficiently detected.

In some embodiments the used electromagnetic radiation may have wavelength between approximately 0.1 to approximately 1 nm. Small wavelength, although generally easier to generate, will cause small diffraction angles which can be difficult to measure. In some cases, measurement of only some higher orders of the diffractive pattern may provide sufficient information.

In some embodiments the used electromagnetic radiation may have wavelength between approximately 1 to approximately 20 nm, which will in generally cause larger diffraction angles, but may cause other problems. Even larger wavelengths are in some cases feasible.

The disclosed method may also use sequentially or simultaneously different wavelengths in order to compensate for various shortcomings of different choices of wavelength.

The diffracted pattern may in some cases be obtained by reflective diffraction and in some cases by transmission diffraction.

In yet another embodiment of the present invention, only the scattered radiation from non-repetitive structures on the chip is used to determine some information about the quality of the fabricated structure. In such a case, the phenomena of diffraction degrades to scattering, i.e., one deals conceptually only with one unit cell in crystallographic sense. While in general less information may be extracted and the mathematical effort, as well as ambiguities, may be higher, in some instances such an embodiment may provide advantages.

A typical detector of the scattered or diffracted radiation will be 2-dimensional, i.e., spatially resolve the diffracted and measured radiation in 2 spatial dimensions. One or zero-dimensional detectors, the relative position of which with respect to the diffracted pattern is spatially scanned, may also be used, although this will in general increase the required time to obtain the desired information. In some embodiments, a single stationary 1-dimensional detector may suffice to obtain a limited amount of useful information.

### DESCRIPTION OF THE DRAWINGS

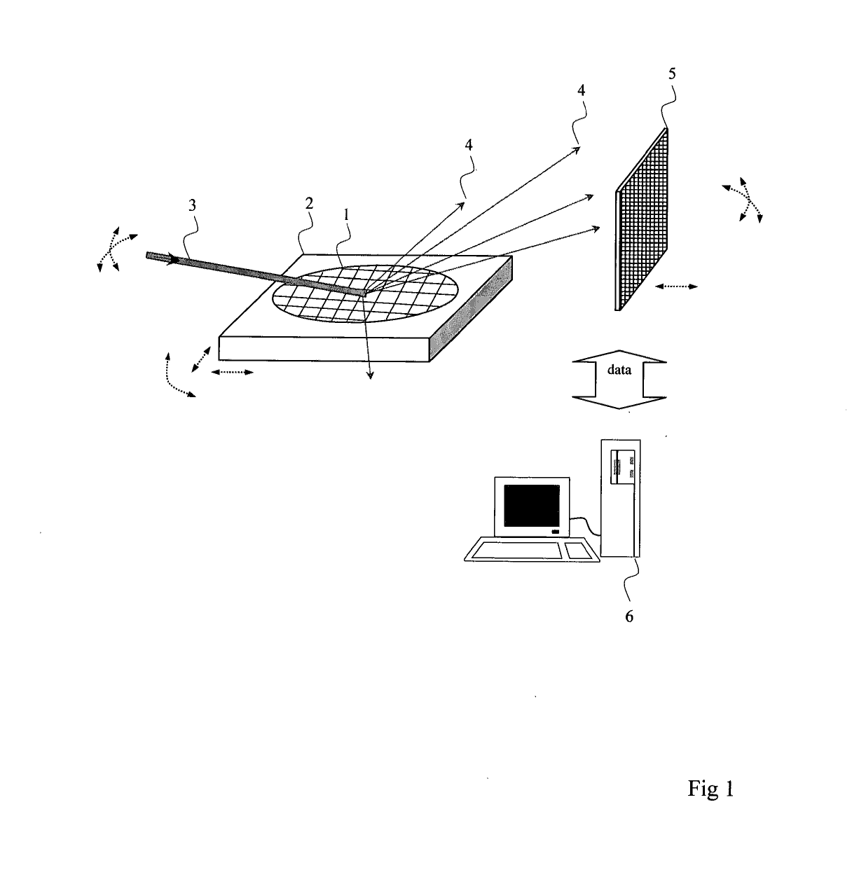

FIG. 1

FIG. 1 shows a principle arrangement for measuring diffractive patterns of electromagnetic waves on integrated structures. A wafer (1) containing several chips is placed on a stage 2 or holder that may be mechanically moved (linearly and/or rotationally), in some cases about several axes. The relative position of an incoming beam of electromagnetic radiation (3), in particular the angles with respect to the plane of the wafer, may be adjusted. In general, several diffracted beams (4) are created, which leave the surface of the illuminated area in various direction. A detector 5, the location of which can also be changed either by translation or rotation, registers the diffracted pattern and feeds the data to a computer 6. Some of these mechanical adjustments may be executed simultaneously, such as, for example, diffracometers.

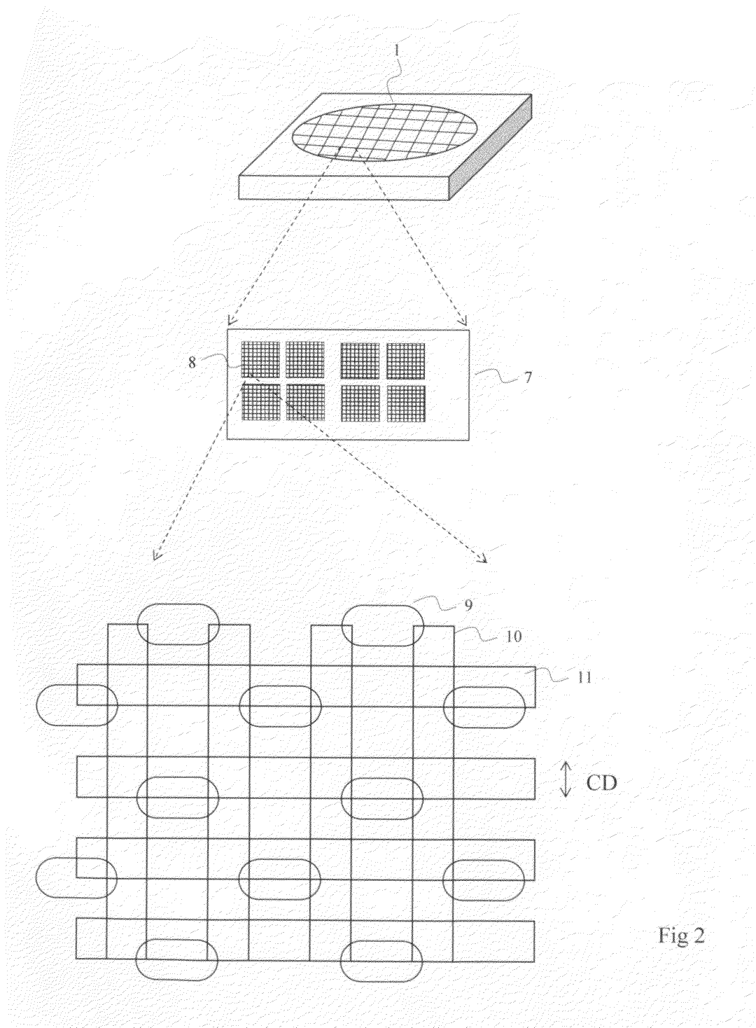

FIG. 2

FIG. 2 shows a wafer (1) that contains several chips (7). Each chip may contain areas which consist of memory blocks, i.e. arrays (8) of memory cells. The memory blocks are made up of repetitive structures, the memory cells. Each block may contain anywhere from a few up to several billion or more cells.

Typical memory cells have an area of only a few CDs by a few CDs, such as, for example, 2 by 3 for some DRAM cells. Such a memory cell would be referred to as a 6f2 cell. As an example, FIG. 2 schematically illustrates a generic memory cell. As an example, the memory cell includes wordlines and bitlines to address the cell.

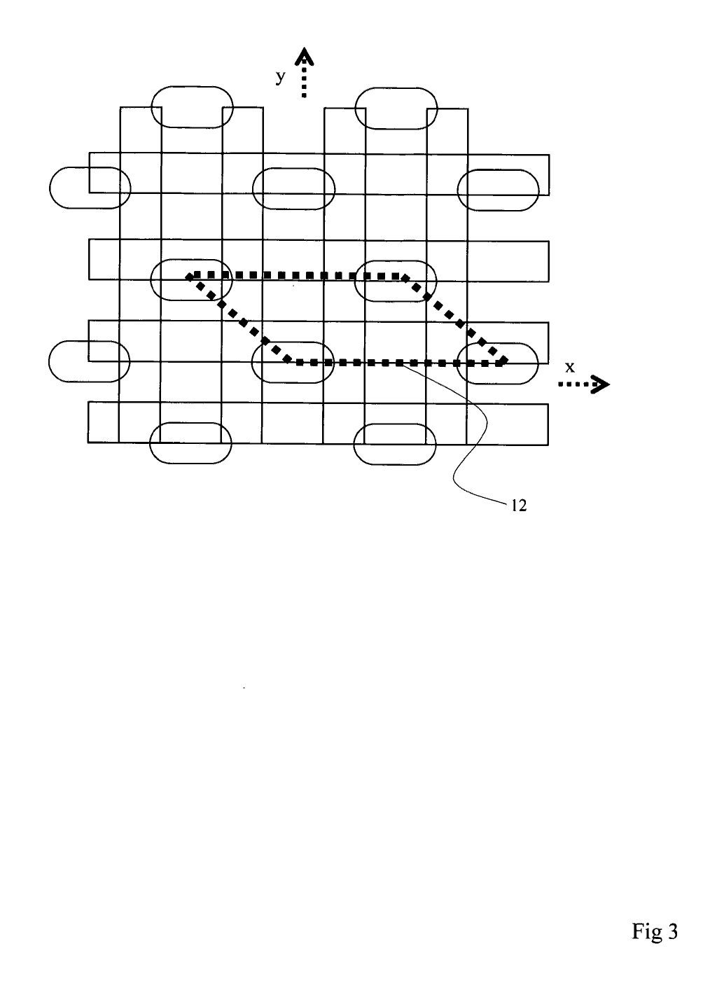

FIG. 3

It is important to realize that such memory arrays can be considered as crystals when considering the sense of diffraction. One can find at least one type of unit cell (12), which by translation in one or more dimensions, would form the entire array.

In general, there may be several alternatives of what is chosen as the conceptual unit cell and how it is placed on the array, but in general it should be the smallest possible unit which, by repeated translation (copying) in one or more dimensions, will create the array.

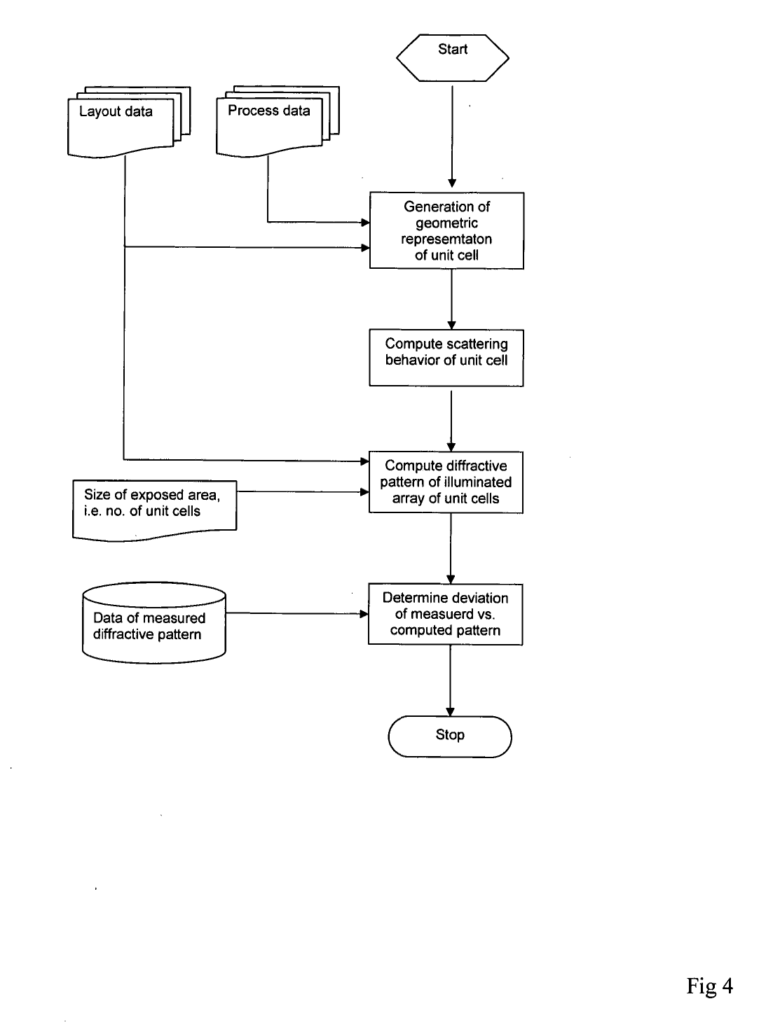

FIG. 4

Based on layout data that were generated during the design of the chip, as well as based on data and knowledge about the process of manufacturing the chip, a geometric representation of an ideal unit cell can be computed. Based on this geometric representation (which may also include certain material properties), the electromagnetic scattering behavior on one such unit cell is computed. The diffractive pattern of the entire exposed portion of the repetitive structure (array) can be computed by superposition. In a simple embodiment only the deviation of the expected pattern from the measured pattern is computed once and some statements on the imperfections of the actually manufactured structure may be possible.

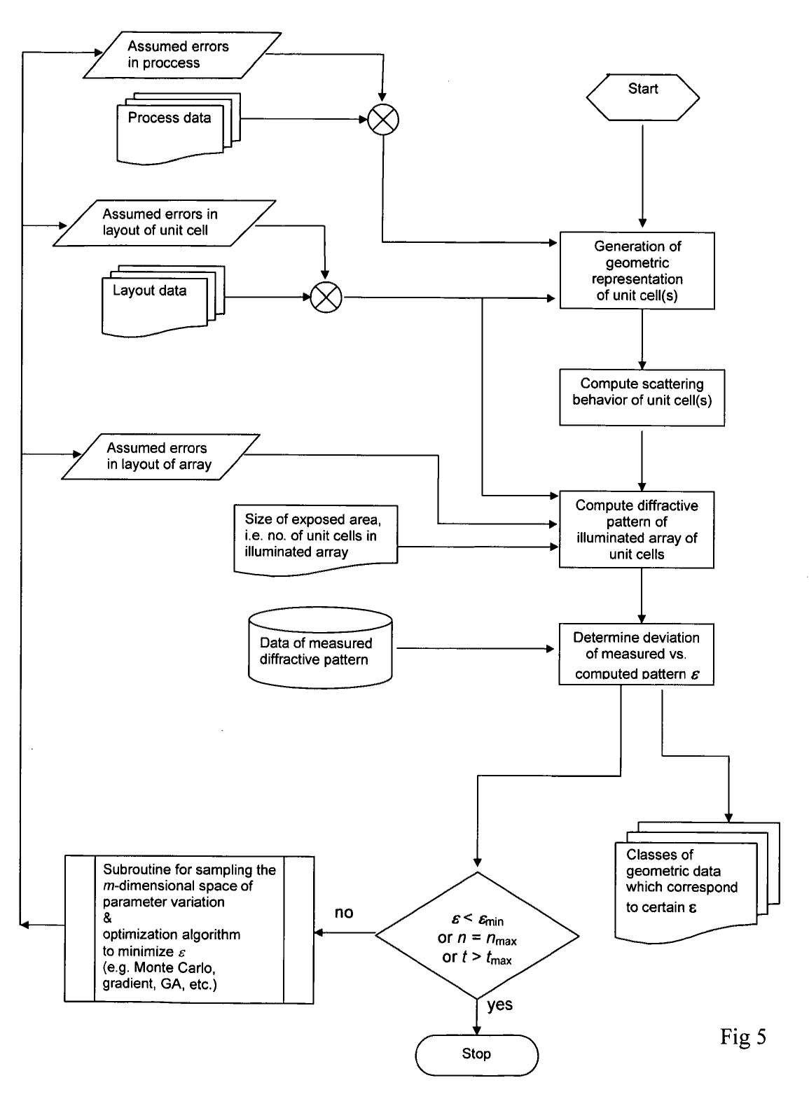

FIG. 5

In another embodiment, an iterative process is used, whereby various parameters of the layout of the unit cell, the manufacturing process, and the repetitive accuracy on an array level are numerically chanced in order to simulate imperfections. In addition, a number of resulting diffractive patterns are computed and the deviation from the observed diffractive pattern is recorded. Various numerical methods may be used to optimize this process. The goal of the optimization is to minimize the deviation of the computed and the measured diffractive pattern. Execution of a large number of such simulations permits one to find classes of structures that are typical for the one that was fabricated, as well as to derive quantitative measures for imperfections of features of interest.

One or more non-ideal conditions of the apparatus (such as incident beam width, beam profile brilliance, illuminated spot size, etc.) may also cause degradation of the measured diffractive pattern. Therefore, the data analysis (including the described iterative scheme) may also take into account systematic measurement errors introduced by the experimental setup in order to attempt to distinguish between deviations of the measured diffractive pattern from the ideal diffractive pattern that were introduced by actual imperfections of the fabricated chip vs. those introduced by the experimental setup.

Although the invention has been described with reference to specific embodiments, it will be understood by those skilled in the art that various changes can be made without departing from the spirit or scope of the invention. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the methods discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method comprising:
exposing spatially repetitive structures on partially or completely fabricated integrated circuits or wafers to electromagnetic radiation, recording the diffractive patterns created thereby, analyzing the collected data and deriving information regarding geometric data with which such repetitive structure were fabricated or aligned.

2. A method according claim 1, wherein partially or completely fabricated arrays of memory cells on integrated circuits or wafers are exposed to electromagnetic radiation.

3. A method according claim 1, further comprising using a source of electromagnetic radiation, means to shape the beam of radiation, means to focus and or collimate the beam, means to position the chip or the wafer relative to the incoming beam of radiation by translation and or rotation, means to move one or more sensors of the radiation, furthermore using elements to filter out the desired wavelength.

4. A method according claim 1, further comprising using direct analytical and or numerical data analysis, furthermore using the data of the measured diffractive pattern, and whereby data are computed which are describing the spatial properties of the structure that was exposed to the electromagnetic radiation.

5. A method according claim 1, further comprising using iterative analytical and or numerical data analysis, whereby at least in part known ideal layout data of the chip and or known ideal or measured fabrication process data are used to compute a theoretical diffractive pattern, comparing the computed diffracted pattern with the measured diffracted pattern, refining assumed geometric parameters in the computed pattern in order to obtain better agreement between computed and measured diffractive pattern, repeating this process until a certain threshold of agreement between computed and measured diffractive pattern is reach, and deriving data from this process describing the spatial properties of the structure that was exposed to the electromagnetic radiation.

6. A method according claim, wherein the computation of the diffractive includes a first step in which the electromagnetic scattering behavior of one spatially receptive unit is determined by analytical or numerical methods, and in a second step the response of the entire exposed structure is computed by superposition of the individual scattering events thereby modeling the effect of diffraction.

7. A method according claim 1, wherein assumed spatial geometric errors are introduced on the level of computing the scattering behavior of the unit cells, subsequently composing the entire diffracted pattern from a number of such unit cells thereby degrading the perfection of the computed diffractive pattern, and thereby modeling variations of the perfection of the interrogated structure.

8. A method according claim 1, wherein assumed spatial geometric errors are introduced on the level of composing the entire diffracted from the scattering behavior of unit cells.

9. A method according claim 1, wherein numerical FDTD or FEM methods are used to solve a full or reduced set of Maxwell's equations to obtain the scattering information for the unit cell.

10. A method according claim 1, wherein dedicated test structures on the chip or wafer are interrogated.

11. A method according claim 1, wherein functional structures on the chip or wafer are interrogated.

12. A method according claim 1, wherein spatial properties with witch metal lines on the chip or wafer were fabricated or deposited is determined.

13. A method according claim 1, wherein spatial properties with witch material was removed from the chip or wafer is determined.

14. A method according claim 1, wherein spatial properties with witch nanotubes on the chip or wafer were fabricated or deposited or aligned is determined.

15. A method according claim 1, wherein the source of electromagnetic radiation is based on deceleration or acceleration of free electric charges in order to generate waves of suitable wavelength.

16. A method according claim 1, wherein the source of electromagnetic radiation is based on plasma to generate waves of suitable wavelength.

17. A method according claim 1, wherein electromagnetic radiation between 0.1 to 20 nm wavelength are used either at a single discrete wave length, or at multiple discrete wave length or at a continuous spectrum.

18. A method according claim 1, wherein the spot of the incoming electromagnetic radiation is placed on the interrogated chip or wafer such that the substantially same area that is used for the computation of the theoretical diffractive pattern is exposed to the electromagnetic radiation.

19. A method according claim 1, wherein the spot of the incoming electromagnetic radiation is scanned over the chip or the wafer in one or two dimensions.

20. A method according claim 1, wherein a coherent source of EM radiation is used, the intensity and phase of the diffracted pattern is recorded, and the computation of the interrogated structure on the chip or wafer which caused the diffractive pattern based on both amplitude and phase information.
